(19) United States
(12) Patent Application Publication
(10) Pub. No.: US 2014/0050472 A1
(43) Pub. Date: Feb. 20, 2014

(54) MOBILE TERMINAL FOR SERVICING A TELECOMMUNICATION SYSTEM

(71) Applicants: Henning Hinderthür, Finning (DE); Wolfgang Kallenbach, Wasungen (DE)

(72) Inventors: Henning Hinderthür, Finning (DE); Wolfgang Kallenbach, Wasungen (DE)

(73) Assignee: ADVA OPTICAL NETWORKING SE, Meiningen (DE)

(21) Appl. No.: 13/970,501

(22) Filed: Aug. 19, 2013

(30) Foreign Application Priority Data
Aug. 20, 2012 (DE) 202012103141.8

(51) Int. Cl. H04B 10/07

(52) U.S. Cl. CPC H04B 10/07
USPC 398/14

(57) ABSTRACT

The invention pertains to a mobile terminal for servicing a telecommunication system, wherein the telecommunication system comprises a system controller and at least one module and/or at least one interface port (that is externally accessible in the inserted state of the module), wherein the mobile terminal features an identification device in order to identify a module or an interface port. The invention further pertains to a utilization of such a mobile terminal, as well as an arrangement consisting of a telecommunication system and such a mobile terminal.

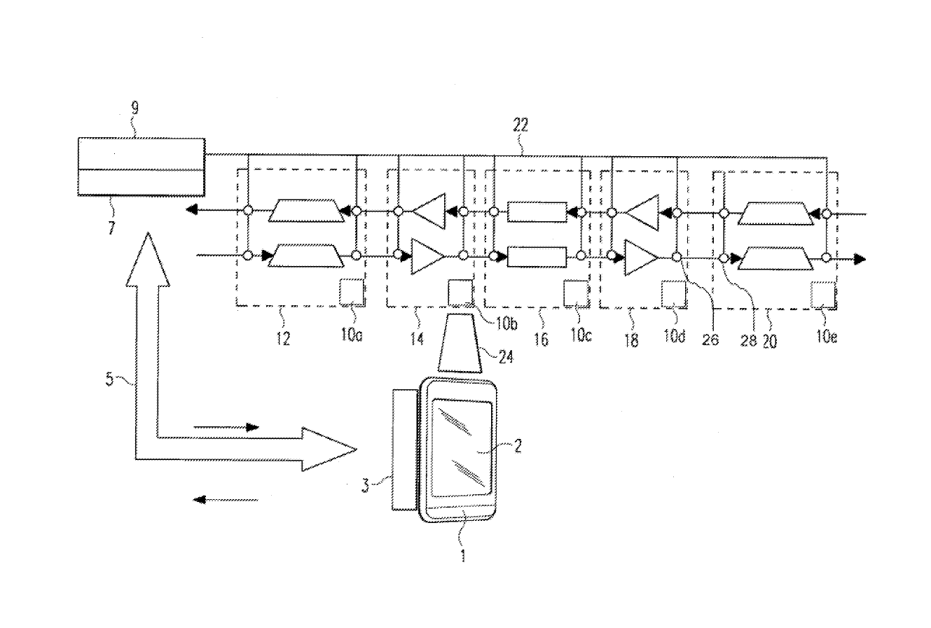

The invention pertains to a mobile terminal for servicing a telecommunication system. Telecommunication systems of this type (i.e., audio, video and/or data transmission systems) such as, for example, optical systems for high-speed transmissions of at least 100 GBit/s, particularly wavelength division multiplexing systems (WDM-systems), comprise several network nodes that frequently are spatially separated by several kilometers (or even hundreds of kilometers). Such network nodes contain a series of electronic components or exchangeable modules and a large number of (optical or electrical) interface ports that are externally accessible in the installed state of the modules.

The network nodes can be centrally serviced by a network operations center (NOC), wherein the NOC is typically connected to all modules of all network nodes for this purpose. In addition, the modules of a network node can also be serviced locally by a system controller provided in the respective network node.

A central servicing solution cannot be used for procedures that require a local intervention on-site such as, for example, the removal, installation or exchange of (hardware) components or changing or checking the wiring such that on-site servicing at the network node is unavoidable in this case.

This work is performed by a field technician, wherein the technician finds an on-site component of the system such as, for example, a rack with compartments (shelves and subshelves) and plug-in units with slots, as well as cards inserted therein. Due to the various designs, the aforementioned components are referred to below as preferably exchangeable modules of the on-site component of a telecommunication system.

In order to perform the required work on any module or to check its wiring, function, etc. on-site, the technician requires exact information on the respective module. However, the identification of a module is not trivial, particularly if a large number of modules are provided, such that errors can occur in the identification or localization of an individual module.

In addition, such high-speed networks are usually realized in the form of optical networks such that optical waveguides or cables are used as connections between individual modules. Individual connections between modules to be connected on the input and output side are produced by means of interface ports of a module on the input and output side that have wave-specific characteristics. The interface ports are therefore situated at an externally accessible location of a module, usually on the faceplate, such that the desired wiring can also be realized externally after the installation of a module.

Due to the complex structure of a network node, a large number of ports (usually several hundred) need to be wired to one another in this case. Due to the multistage structure, no equivalent alternatives are available for this wiring (in contrast to a bus system) such that the wiring of the interface ports needs to be realized in a predefined fashion, namely biuniquely. Checks of the wiring, as well as procedures that require at least partial rewiring, are therefore complex tasks with high error probability.

The present invention is therefore based on the objective of developing a device, as well as a utilization of this device, that simplifies a biunique identification or localization of a module or an interface port of a telecommunication system and assists in avoiding errors such as, in particular, incorrect wiring.

According to the invention, this objective is attained with a device with the characteristics of claim 1 and with a utilization of this device in accordance with the characteristics of claim 7.

According to the invention, a mobile terminal (for example a smartphone, a tablet PC, a notebook or a laptop) is used as an aid for simplifying the work to be performed by the technician. For this purpose, the mobile terminal features an identification device, by means of which a module and/or interface port etc. that is preferably provided with an identification or label can be identified. After the identification and therefore localization of a module, module-specific or port-specific information can be displayed on a display unit of the mobile terminal. Instead of identifying a label such as, for example, a 1-D, 2-D or 3-D barcode, any non-electronic marking or even an RFID tag, it would naturally also be conceivable to identify a module by means of an image analysis between an existing actual pattern and a stored nominal pattern of the respective module.

In this case, the nominal patterns required for any pattern recognition may be stored in a local database of the mobile terminal and/or in the system in a decentralized fashion (in a database of a system controller) at a network node and/or in a centralized fashion in a network operations center (NOC).

For this purpose, the mobile terminal features an identification device such as, for example, a camera for the image recognition or a receiver for an RFID tag. In addition, the mobile terminal features a communication device in order to allow a bidirectional communication directly with the local network node or the system controller contained therein and/or directly with the NOC. It is naturally also possible to exchange data with the NOC via a communication link with the system controller and therefore indirectly with the NOC data—instead of a direct communication with the NOC. In this respect, the communication can be established via various links and wired connections (particularly a USB connection) or wireless connections such as, for example, Bluetooth, WLAN, GPRS, UMTS or LTE.

According to the invention, module-specific or port-specific data are also transmitted via the aforementioned communication links and then output on a display unit such as, for example, a display of the mobile terminal in order to productively assist the field technician in his work.

In a preferred embodiment of the invention, performance data, the alarm history or pieces of wiring information of the identified module or port are transmitted and displayed as module-specific and/or port-specific data such that a variety of essential pieces of information is available to a field technician during his work.

Other advantageous embodiments of the invention result from the dependent claims.

The invention is described in greater detail below with reference to an exemplary embodiment that is illustrated in the drawing.

The only FIGURE schematically shows a network node of a telecommunication system (a system for video, audio and data transmission), particularly a high-speed system with transmission rates of at least 100 GBit/s (and up to one or more TeraBit/s), and a mobile terminal according to the invention, for example in the form of a smartphone.

The network node usually comprises a rack with compartments (shelves and subshelves) contained therein and plug-in units or plug-in frames (for example, plug-in units with a width of 19 inches), into the slots of which cards 12, 14, 16, 18, 20, for example up to 20 cards, can be inserted. The cards 12, 14, 16, 18, 20 feature at least one interface port 28 on the input side and one interface port 26 on the output side, wherein each card 12, 14, 16, 18, 20 may by all means feature several interface ports 26, 28 such as, for example, four interface ports per card 12, 14, 16, 18, 20 as illustrated in the drawing or even more interface ports.

Alternatively or additionally to the interface ports 26, 28 shown, it would naturally also be possible to provide interface ports in the plug-in frames (shelves or subshelves) or in the rack itself.

Biunique wiring without alternatives is required due to the specific properties, particularly wavelength-specific properties, of the interface ports 26, 28 (mostly optical interfaces with adapted wiring between one another) and due to the multistage structure of the network node. For this purpose, ports 26, 28 on the input side and the output side of respectively adjacent pairs 12; 14, 14; 16, 16; 18 and 18; 20 of the cards are directly connected to one another from output to input and input to output (in accordance with the direction of the arrows in the FIGURE) as illustrated in the drawing, preferably along the shortest possible path. In this respect, the arrangement that is schematically illustrated in the form of neighboring pairs in the drawing is representative of modules that belong together or need to be directly connected to one another, wherein the actual (spatial) arrangement in the slots or in a rack does not necessarily have to be interpreted in the form of direct neighbors. For example, it is conceivable that a card 12, 14, 16, 18, 20 could also be connected to a card 12, 14, 16, 18, 20 that is spatially arranged at a greater distance or its interface ports 26, 28, respectively.

The number of externally accessible interface ports 26, 28 to be wired in a network node of an aforementioned system, such as, for example, a Metronet, can quickly amount to a hundred or even hundreds of ports.

For example, at a conventional number of at least two, four, eight or more interface ports 26, 28 per card, as well as up to 20 cards per shelf (with a conventional width, for example, of 19 inches) and several shelves per rack of a network node, it is necessary to wire a hundred or several hundred ports.

In order to easily install, service or change this externally accessible (usually frontal) wiring, labels or identifications 10a, 10b, 10c, 10d, 10e are provided at an externally accessible location, for example frontally, in order to allow a positive identification of the respective card 12, 14, 16, 18, 20. Due to the different arrangement of the interface ports 26, 28 on a card 12, 14, 16, 18, 20, the respective interface port 26, 28 can also be biuniquely identified and localized. In addition, it would naturally also be possible to provide each interface port 26, 28 of a card 12, 14, 16, 18, 20 with an identification.

The identifications 10a, 10b, 10c, 10d, 10e may be realized, for example, in the form of a 1-D or 2-D barcode and can be detected (area 24) by the camera of a smartphone 1 and recognized as indicated in the drawing by means of the identification 10b. In this case, a pattern comparison between the detected (actual) pattern and a nominal pattern known to the system is preferably carried out such that the actual pattern can be identified if it corresponds to the nominal pattern to a predetermined extent. However, it would naturally also be conceivable to utilize different types of pattern recognition or even an optical comparison between an existing actual wiring (image recognition of an actual pattern as identification) and a desired nominal wiring (stored nominal image pattern).

After the successful identification and localization of a card 12, 14, 16, 18, 20 and therefore its respective interface ports 26, 28, card-specific or port-specific information can be displayed on a display unit 2, for example, in the form of a color display. It would be possible, for example, to display a correct nominal wiring or a corresponding section of the overall layout, based on which the field technician can easily install, check or change the actual wiring.

Alternatively or additionally to wiring information, other data such as performance data, the alarm history, etc. of the identified module or port may naturally also serve as module-specific information or card-specific or port-specific information in order to assist the field technician in the work to be performed. For example, an exchange of a card or another module due to a functional change or a defect can be significantly simplified with an inventive on-site identification and localization of the module in the network node.

Analogous to an actual pattern, the card-specific or port-specific information may in this case be stored in the smartphone 1 or in its memory, and/or retrieved on demand in accordance with the detected or recognized identification 10a, 10b, 10c, 10d, 10e by a higher-level unit.

In order to communicate with a higher-level unit, the smartphone 1 features a—preferably wireless—interface such as, for example, a Bluetooth interface 3, by means of which a bidirectional communication link 5 with a system controller 9 can be established via its preferably wireless interface 7. It would naturally also be conceivable to establish a data link by means of a direct (optical or electronic) connection such as, for example, a USB connection—instead of a wireless communication link 5.

The higher-level unit, from which the aforementioned data are requested, typically is the local system controller 9 because this component or this module (for example a storage device of the system controller 9) of the network node usually contains all network node-specific or even module-specific information and the system controller 9 is connected to many—preferably all—modules of a network node. For this purpose, the system controller may be connected to all ports 26, 28 of the cards 12, 14, 16, 18, 20 by means of a connection 22 as schematically illustrated in the drawing. In this way, all signals applied to the respective input and output signal points of the modules, particularly cards, are available to the system controller 9 for the evaluation, control, etc.

However, it would naturally also be possible to at least partially request the aforementioned data from a centralized higher-level unit in the form of the NOC. In this case, the communication may either be realized indirectly via the system controller 9 that is once again connected to the NOC or via a direct communication link such as, for example, a UMTS connection or an Internet connection, particularly a VPN connection, between the smartphone and the NOC. In this way, it would also be possible, for example, to upgrade a local database in the system controller or its storage device in a centralized fashion.

In addition to providing a module or interface port 26, 28 with an identification 10a, 10b, 10c, 10d, 10e, it would also be conceivable to additionally identify the connectors (plug connectors), particularly the optical connectors, on the cable (ends) in order to simplify an allocation between a port and a connector of a cable.

### List of Reference Symbols

1 Smartphone
2 Display unit
3 Bluetooth interface
5 Communication link (bidirectional)
7 Bluetooth interface
9 System controller
10a Identification/label
10b Identification/label
10c Identification/label
10d Identification/label
10e Identification/label
12 Module/card
14 Module/card
16 Module/card
18 Module/card
20 Module/card
22 Connection with system controller
24 Camera recognition area
26 Interface port (output)
28 Interface port (input)

1. A mobile terminal for servicing a telecommunication system, wherein the telecommunication system comprises a system controller (9) and at least one module (12, 14, 16, 18, 20) and/or at least one interface port (26, 28) (that is externally accessible in the inserted state of the module),
characterized in that
the mobile terminal features an identification device for identifying a module (12, 14, 16, 18, 20) or an interface port (26, 28),
the mobile terminal features a communication device (3) in order to communicate with the system controller (9) and to receive module-specific or port-specific data in dependence on the identified module (12, 14, 16, 18, 20) or the identified interface port (26, 28), and
the mobile terminal features a display unit (2) for displaying module-specific or port-specific information.

2. The mobile terminal according to claim 1, characterized in that the mobile terminal is realized in the form of a smartphone (1), a tablet PC, a notebook or a laptop.

3. The mobile terminal according to claim 1 or 2, characterized in that the module (12, 14, 16, 18, 20) or the interface port (26, 28) is provided with at least one identification (10a, 10b, 10c, 10d, 10e).

4. The mobile terminal according to claim 3, characterized in that a barcode (1-D, 2-D or 3-D) is used as identification (10a, 10b, 10c, 10d, 10e).

5. The mobile terminal according to one of the preceding claims, characterized in that the identification device features a camera in order to allow the identification of a module (12, 14, 16, 18, 20), an interface port (26, 28) or an identification (10a, 10b, 10c, 10d, 10e) by means of image recognition.

6. The mobile terminal according to one of the preceding claims, characterized in that the module-specific or port-specific data consist of performance data, the alarm history or wiring information of the identified module (12, 14, 16, 18, 20) or port (26, 28).

7. A utilization of a mobile terminal according to one of the preceding claims for servicing a telecommunication system, wherein the telecommunication system comprises a system controller (9) and at least one module (12, 14, 16, 18, 20) and/or at least one interface port (26, 28).

8. The utilization of a mobile terminal according to claim 7, characterized in that the telecommunication system consists of a wavelength division multiplexing (WDM) system.

9. An arrangement consisting of a telecommunication system and a mobile terminal according to one of claims 1 to 6.
